(19) United States
(12) Patent Application Publication
(10) Pub. No.: US 2020/0166365 A1
(43) Pub. Date: May 28, 2020

(54) NAVIGATION DEVICE, NAVIGATION INFORMATION PROCESSING DEVICE, AND NAVIGATION INFORMATION ACCEPTANCE DEVICE

(71) Applicant: SONY CORPORATION, TOKYO (JP)

(72) Inventor: YASUHIDE HOSODA, KANAGAWA (JP)

(21) Appl. No.: 16/621,097

(22) PCT Filed: May 18, 2018
(86) PCT No.: PCT/JP2018/019261

§ 371 Date: Dec. 10, 2019

(30) Foreign Application Priority Data
Jun. 29, 2017 (JP) 2017-127694

(51) Int. Cl. G01C 21/36; G06F 3/14; G06F 3/16

(52) U.S. Cl. CPC G01C 21/3617; G01C 21/3697; G06F 3/165; G06F 3/14

(57) ABSTRACT

A navigation device according to an embodiment of the present disclosure includes: an acceptance unit that accepts a request; a determination unit that determines a representation allowing a user to have fun while traveling on the basis of the request accepted by the acceptance unit; and an output unit that generates a control signal causing a representation device to perform the representation determined by the determination unit, and outputs the control signal to the representation device.

### TECHNICAL FIELD

The present technology relates to a navigation device, a navigation information processing device, and a navigation information acceptance device.

### BACKGROUND ART

In recent years, in-vehicle or portable navigation devices have become popular. Some mobile phones and so-called smartphones have a positioning function and are usable as navigation devices.

### CITATION LIST

### Patent Literature

PTL 1: Japanese Unexamined Patent Application Publication No. 2015-180887

### SUMMARY OF THE INVENTION

As a frequent situation in which a navigation device is used, the navigation device is used to search for a route from a fixed location to a fixed destination such as a route from home to an office or from an office to home. For this reason, the existing navigation devices are designed to reliably guide a user to the destination, and is not suitable for having fun while traveling. It is therefore desirable to provide a navigation device, a navigation information processing device, and a navigation information acceptance device that make it possible to have fun while traveling.

A navigation device according to an embodiment of the present technology includes: an acceptance unit that accepts a request; a determination unit that determines a representation allowing a user to have fun while traveling on the basis of the request accepted by the acceptance unit; and an output unit that generates a control signal causing a representation device to perform the representation determined by the determination unit, and outputs the control signal to the representation device.

In the navigation device according to the embodiment of the present technology, the representation allowing the user to have fun while traveling is determined on the basis of the accepted request, and the control signal causing the representation device to perform the determined representation is generated, and is outputted to the representation device. As a result, the representation allowing the user to have fun while traveling is performed in the representation device.

A navigation information processing device according to an embodiment of the present technology includes a storage unit that stores a plurality of pieces of navigation information including route information and information about a situation, a mood, or a preference of a user. The route information includes a departure point, an arrival point, and a via point, and the information is associated with the route information. The navigation information processing device further includes a transmitter that reads the navigation information corresponding to a request from an external device from among the plurality of pieces of navigation information stored in the storage unit, and transmits the navigation information to the external device.

In the navigation information processing device according to the embodiment of the present technology, the navigation information including the representation information is transmitted to the external device in response to the request from the external device. This makes it possible to perform a representation allowing the user to have fun while traveling in the external device.

A navigation information acceptance device according to an embodiment of the present technology includes: an acceptance unit that accepts information about a situation, a mood, or a preference of a user as a request during driving; and a transmitter that transmits the request accepted by the acceptance unit together with route information including a departure point, an arrival point, and a via point to a server device.

In the navigation information acceptance device according to the embodiment of the present technology, the representation information is received by the acceptance unit, and the representation information received by the acceptance unit is transmitted together with the route information to the server device. This makes it possible to perform a representation allowing the user to have fun while traveling in an external device that reads the route information and the representation information from the server device.

According to the navigation device, the navigation information processing device, and the navigation information acceptance device according to the embodiments of the present technology, it is possible to perform a representation allowing the user to have fun while traveling in the representation device or the external device, which makes it possible for a user of the representation device or the external device to have fun while traveling. It is to be noted that effects of the present technology are not necessarily limited to the effects described here, and may be any of the effects described in this specification.

### BRIEF DESCRIPTION OF THE DRAWINGS

FIG. 1 is a diagram illustrating a schematic configuration example of a navigation system according to an embodiment of the present technology.

FIG. 2 is a diagram illustrating a schematic configuration example of a data server device in FIG. 1.

FIG. 3 is a diagram illustrating an example of navigation information in FIG. 2.

FIG. 4 is a diagram illustrating an example of a database including editor information in FIG. 2.

FIG. 5 is a diagram illustrating a schematic configuration example of an SNS (social networking service) server device in FIG. 1.

FIG. 6 is a diagram illustrating a schematic configuration example of a schedule server device in FIG. 1.

FIG. 7 is a diagram illustrating a schematic configuration example of a web server device in FIG. 1.

FIG. 8 is a diagram illustrating a schematic configuration example of one terminal device in FIG. 1.

FIG. 9 is a diagram illustrating a schematic configuration example of another terminal device in FIG. 1.

FIG. 10 illustrates an example of a user interface displayed on a display unit in FIG. 8.

FIG. 11 is a diagram illustrating an example of a procedure of registering navigation information in the navigation system in FIG. 1.

FIG. 12 is a diagram illustrating an example of the user interface displayed on the display unit in FIG. 8.

FIG. 13 is a diagram illustrating an example of a procedure of selecting navigation information in the navigation system in FIG. 1.

FIG. 14 is a diagram illustrating an example of the user interface displayed on the display unit in FIG. 8.

FIG. 15 is a diagram illustrating an example of the user interface displayed on the display unit in FIG. 8.

FIG. 16 is a diagram illustrating an example of a procedure of designating a drive editor in the navigation system in FIG. 1.

FIG. 17 is a diagram illustrating an example of the user interface displayed on the display unit in FIG. 8.

FIG. 18 is a diagram illustrating an example of a procedure of designating navigation information in the navigation system in FIG. 1.

FIG. 19 is a diagram illustrating an example of the user interface displayed on the display unit in FIG. 8.

FIG. 20 is a diagram illustrating an example of a procedure of guiding a route in the navigation system in FIG. 1.

FIG. 21 is a diagram illustrating an example of the user interface displayed on the display unit in FIG. 8.

FIG. 22 is a diagram illustrating an example of a procedure of guiding a route in the navigation system in FIG. 1.

FIG. 23 is a diagram illustrating an example of the user interface displayed on the display unit in FIG. 8.

FIG. 24 is a diagram illustrating an example of a procedure of calling a drive editor through an advertisement in the navigation system in FIG. 1.

FIG. 25 is a diagram illustrating a state in which communication is performed between the terminal device in FIG. 8 and an in-vehicle device of a mobile body.

FIG. 26 is a diagram illustrating a schematic configuration example of the in-vehicle device in FIG. 25.

FIG. 27 is a diagram illustrating an example of a state in a case where VR (virtual reality) is used in the navigation system in FIG. 1.

### MODES FOR CARRYING OUT THE INVENTION

Some embodiments of the present technology are described below in detail with reference to the drawings. It is to be noted that description is given in the following order.

### 1. Embodiment

Example in which a drive editor performs a representation

### 2. Modification Examples

Example in which a drive editor conceals a driving route

Example in which a terminal device is an in-vehicle device

Example in which a terminal device communicates with an in-vehicle device

Example in which a terminal device decides a representation

### 3. Examples

Example in which a drive editor performs autonomous driving

### 1. EMBODIMENT

### [Configuration]

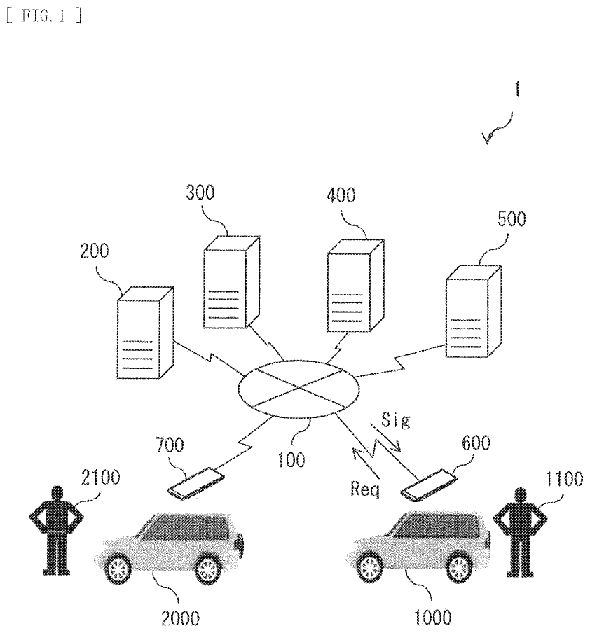

Description is given of a navigation system 1 according to an embodiment of the present technology. FIG. 1 illustrates a schematic configuration example of the navigation system 1. The navigation system 1 is a system having a function of guiding a route to a destination and allowing a user to have fun while traveling. An existing navigation system is often used to search a route from a fixed location to a fixed destination. For this reason, the existing navigation device is designed to reliably guide a user to the destination, and is not suitable for having fun while traveling. In contrast, the navigation system 1 according to the present embodiment is designed not only for route search and a route guide, but also for allowing the user to have fun while traveling. That is, it can be said that the navigation system 1 is a navigation system having entertainment characteristics.

The navigation system 1 includes a data server device 200, an SNS server device 300, a schedule server device 400, a web server device 500, a terminal device 600, and a terminal device 700. The data server device 200 corresponds to a specific example of a “navigation information processing device” of the present technology. The web server device 500 corresponds to a specific example of a “navigation device” and a “server device” of the present technology. The terminal device 600 corresponds to a specific example of a “navigation information acceptance device”, a “representation device”, and an “external device” of the present technology.

The data server device 200, the SNS server device 300, the schedule server device 400, the web server device 500, the terminal device 600, and the terminal device 700 are coupled to one another through a network 100. The network 100 is, for example, a network that performs communication with use of a communication protocol (TCP/IP) that is normally used in the Internet. The network 100 may be, for example, a secure network that performs communication with use of its own communication protocol. The network 100 is, for example, the Internet, an intranet, or a local area network. Coupling between the network 100 and the data server device 200, the SNS server device 300, the schedule server device 400, the web server device 500, the terminal device 600, or the terminal device 700 may be made through, for example, a wired LAN (Local Area Network), a wireless LAN such as Wi-Fi, or mobile telephone lines.

### (Data Server Device 200)

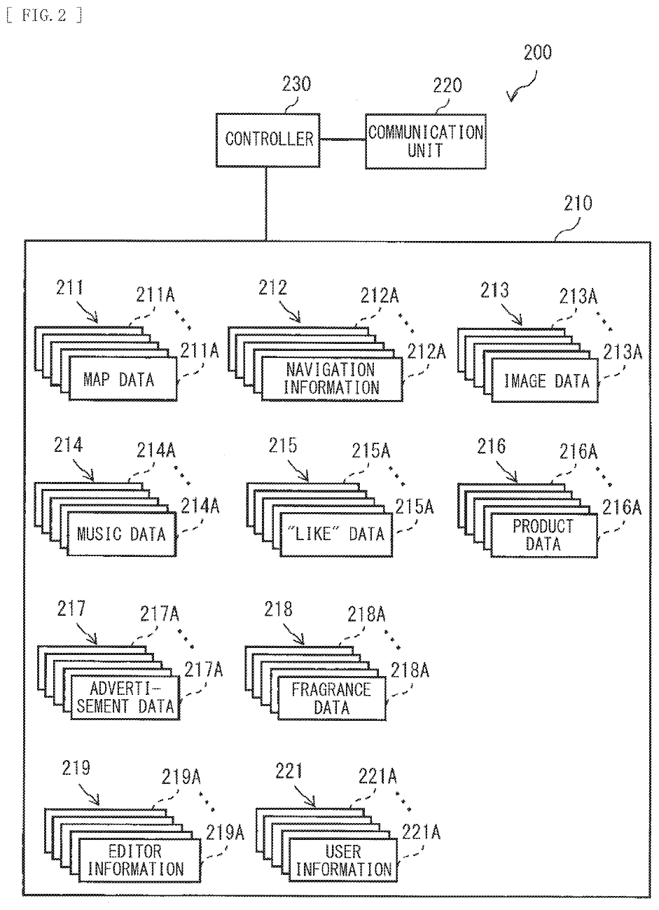

FIG. 2 illustrates a schematic configuration example of the data server device 200. The data server device 200 includes, for example, a storage unit 210, a communication unit 220, and a controller 230. The storage unit 210 corresponds to a specific example of a “storage unit in a navigation information processing device” of the present technology. The controller 230 corresponds to a specific example of a “transmitter in a navigation information processing device” of the present technology.

The controller 230 processes information inputted from outside through the communication unit 220, and outputs information read from the storage unit 210 to outside through the communication unit 220. The controller 230 reads, from the storage unit 210, navigation information 212A corresponding to a request Req from the web server device 500 from among a plurality of pieces of navigation information 212A (to be described later) stored in the storage unit 210, and sends the navigation information 212A to the web server device 500. The communication unit 220 communicates with other devices through the network 100.

The storage unit 210 includes, for example, a nonvolatile memory, and includes, for example, an EEPROM (Electrically Erasable Programmable Read-Only Memory), a flash memory, a resistance-change memory, or the like. The storage unit 210 has, for example, databases 211 to 219 and 211 organized for easy search and easy storage.

The database 211 includes, for example, a plurality of pieces of map data 211A partitioned for respective regions. The database 212 includes, for example, the plurality of pieces of navigation information 212A. Each of the pieces of the navigation information 212A includes, for example, route information 212a and representation information 212b as illustrated in FIG. 3. The route information 212a is map data from a departure point to an arrival point. The route information 212a includes, for example, addresses or GPS (Global Positioning System) data of the departure point, the arrival point, and a via point. The route information 212a may further include, for example, a route name, an introduction of a route, and the like. The representation information 212b is information for allowing a user to have fun while traveling from the departure point to the arrival point. The representation information 212b includes, for example, respective data storage locations and respective map data of an image, music, a “Like” point, a product, an advertisement, and a fragrance.

In the representation information 212b, the map data of the image includes an address or GPS data of a predetermined point on a route, and one piece of image data 213A to be described later is stored in the data storage location of the image. In the representation information 212b, the map data of the music includes an address or GPS data of a point to start to play BGM (Back Graund Music) on the route, and one piece of music data 214A to be described later is stored in the data storage location of the music. In the representation information 212b, the map data of the “Like” point includes an address or GPS data of a point of interest on the route (for example, a building, a landscape, a shop, etc.), and one piece of “Like” data 215A to be described later is stored in the data storage location of the “Like” point. In the representation information 212b, the map data of the product includes an address or GPS data of a point where the product is sold on the route, and one piece of product data 216A to be described later is stored in the data storage location of the product. In the representation information 212b, the map data of the advertisement includes an address or GPS data of a point where the advertisement is displayed on the route, and one piece of advertisement data 217A to be described later is stored in the data storage location of the advertisement. In the representation information 212b, the map data of the fragrance includes an address or GPS data of a point to start to release the fragrance on the route, and one piece of fragrance data 218A to be described later is stored in the data storage location of the fragrance.

The database 213 includes, for example, a plurality of pieces of image data 213A. Each of the pieces of image data 213A is data of an image at a predetermined point on the route. The database 214 includes, for example, a plurality of pieces of music data 214A. Each of the pieces of music data 214A is data of music that starts to be played from a predetermined point on the route. The database 215 includes, for example, a plurality of pieces of “Like” data 215A. Each of the pieces of “Like” data 215A is data about a point of interest (for example, a building, a landscape, a shop, etc.) on the route. The database 216 includes, for example, a plurality of pieces of product data 216A. Each of the pieces of product data 216A is data about a product sold in a shop on the route. The database 217 includes, for example, a plurality of pieces of advertisement data 217A. Each of the pieces of advertisement data 217A is data about an advertisement of a shop on the route. The database 218 includes, for example, a plurality of pieces of fragrance data 218A. Each of the pieces of fragrance data 218A is data of a fragrance that starts to be released from a predetermined point on the route.

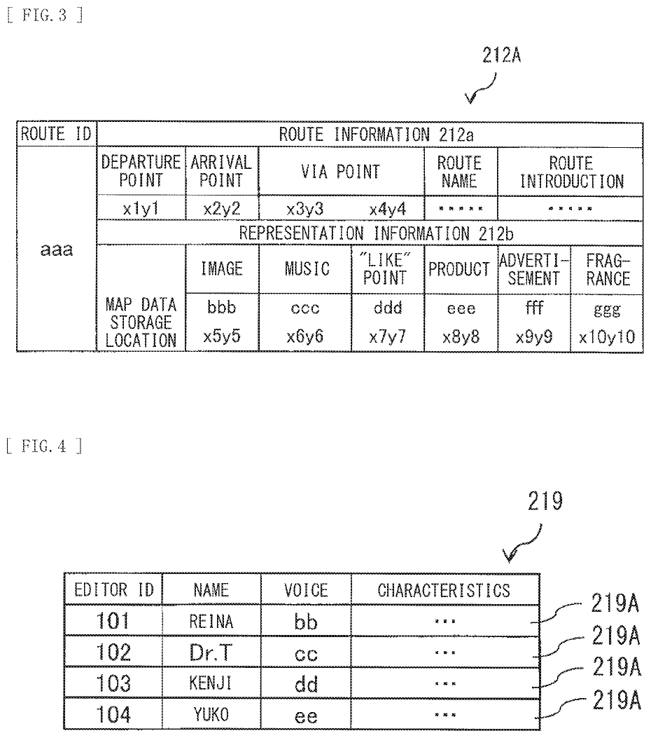

The database 219 includes, for example, a plurality of pieces of editor information 219A. For example, as illustrated in FIG. 4, each of the pieces of editor information 219A includes information about an ID (an editor ID) of a drive editor DE, a name of the drive editor, a voice of the drive editor, and characteristics of the drive editor DE. Here, the drive editor DE refer to an agent that are virtually characterized by execution of a program (a web application program 512 to be described later). The drive editor DE herein has a name defined for each editor ID in the editor information 219A. In the editor information 219A, for example, a name such as Reina, Dr. T, Kenji, or Yuko is set for each editor ID. The drive editor DE has a voice (sound) defined for each editor ID in the editor information 219A. In the editor information 219A, a voice library is set for each editor ID. The drive editor DE has characteristics (for example, personality) defined for each editor ID in the editor information 219A. In the editor information 219A, a numerical value of a parameter relating to the characteristics (for example, personality) is set for each editor ID.

The database 221 includes, for example, a plurality of pieces of user information 221A. Each of the pieces of user information 221A includes, for example, a user ID, a password, a usage history, a selection history, and preference data. In the user information 221A, the usage history includes, for example, a route ID, and usage dates and times of the navigation information 212A used in the past. In the user information 221A, the selection history includes, for example, route selection information to be described later, editor designation information to be described later, designated route information to be described later, and the like. In the user information 221A, the preference information includes information about user's preferences (for example, a preference for a shortest route, high priority to time, liking noodles, collecting bags, and liking history).

### (SNS Server Device 300)

FIG. 5 illustrates a schematic configuration example of the SNS server device 300. The SNS server device 300 includes, for example, a storage unit 310, a communication unit 320, and a controller 330. The controller 330 processes information inputted from outside through the communication unit 320, and outputs information read from the storage unit 310 to outside through the communication unit 320. The communication unit 320 communicates with other devices through the network 100.

The database 311 includes, for example, a plurality of pieces of text data 311A. Each of the pieces of text data 311A include text data posted to an SNS. The database 312 includes, for example, a plurality of pieces of image data 312A. Each of the pieces of image data 312A includes image data posted to an SNS.

### (Schedule Server Device 400)

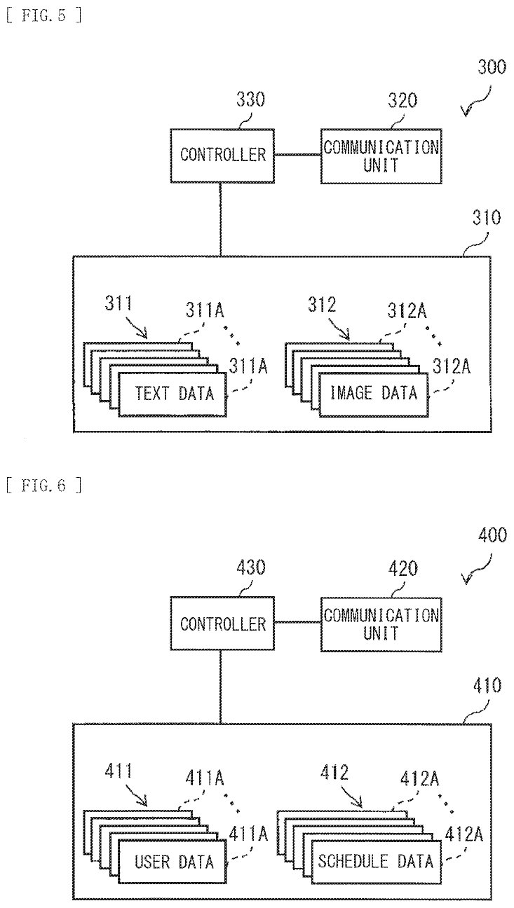

FIG. 6 illustrates a schematic configuration example of the schedule server device 400. The schedule server device 400 includes, for example, a storage unit 410, a communication unit 420, and a controller 430. The controller 430 processes information inputted from outside through the communication unit 420, and outputs information read from the storage unit 410 to outside through the communication unit 420. The communication unit 420 communicates with other devices through the network 100.

The database 411 includes, for example, a plurality of pieces of user data 411A. Each of the pieces of user data 411A includes, for example, a user ID. The database 412 includes, for example, a plurality of pieces of schedule data 412A. Each of the pieces of schedule data 412A includes schedule data for each of the pieces of user data 411A. It is possible to make out spare time of the user from each of the pieces of schedule data 412A.

### (Web Server Device 500)

FIG. 7 illustrates a schematic configuration example of the web server device 500. The web server device 500 provides a user interface in the terminal devices 600 and 700. The web server device 500 further provides a representation in the terminal device 600. The web server device 500 includes, for example, a storage unit 510, a communication unit 520, and a controller 530. The controller 530 corresponds to a specific example of “an acceptance unit, a determination unit, and an output unit in a navigation device” of the present technology.

The communication unit 520 communicates with other devices (for example, the data server device 200, etc.) in the navigation system 1 through the network 100. The storage unit 510 includes, for example, a nonvolatile memory, and includes, for example, an EEPROM, a flash memory, a resistance-change memory, or the like. The storage unit 510 stores programs (for example, a web server program 511 and the web application program 512) to be executed by the controller 530. The web application program 512 is an application program to be used through the network 100. The web application program 512 is a program that describes procedures to be executed in a creative mode, a select mode, and a drive mode that are to be described later. The web application program 512 operates by coordination between the web server program 511 and a web browser program 611 to be described later or a web browser program 711 to be described later.

The controller 530 includes a processor, and executes, for example, the web server program 511, the web application program 512, and the like that are stored in the storage unit 510. A function of the controller 530 is performed, for example, by execution of the web server program 511 and the web application program 512 by the controller 530.

The controller 530 accepts, from the terminal device 600, a request Req from the user. The request Req from the user includes, for example, designation (appointment) of a drive editor, designation of the navigation information 212A, a request for adjustment to the navigation information 212A, a request to leave driving to the drive editor DE, or the like. The “request for adjustment” includes, for example, information about a situation, a mood, or a preference of the user. The “situation of the user” in the “request for adjustment” includes information about a schedule or spare time of the user.

The controller 530 determines a representation that allows the user to have fun while traveling on the basis of the accepted request Req. The controller 530 generates a control signal Sig1 that causes the terminal device 600 to perform the determined representation (or a representation corresponding to the request Req), and outputs the generated signal Sig1 to the terminal device 600. The control signal Sig1 corresponds to a specific example of a “control signal” and a “first control signal” of the present technology. On the basis of the accepted request Req, the controller 530 generates, for example, the control signal Sig1 that causes an image of a place of interest on a display unit 640 of the terminal device 600, and transmits the control signal Sig1 to the terminal device 600 through the communication unit 520. On the basis of the accepted request Req, the controller 530 generates the control signal Sig1 that causes a speaker unit 650 of the terminal device 600 to output music appropriate to the place of interest, for example, and transmits the control signal Sig1 to the terminal device 600 through the communication unit 520. On the basis of the accepted request Req, the controller 530 generates the control signal Sig1 that causes the display unit 640 or the speaker unit 650 of the terminal device 600 to output information about, for example, a place of interest to which a “Like” point is given, and transmits the control signal Sig1 to the terminal device 600 through the communication unit 520. On the basis of the accepted request Req, the controller 530 generates the control signal Sig1 that causes a fragrance diffuser 670 of the terminal device 600 to output a fragrance appropriate to characteristics of the drive editor DE, for example, and transmits the control signal Sig1 to the terminal device 600 through the communication unit 520.

In a case where the request Req from the user includes information about the drive editor DE designated (appointed) by the user, the representation in the terminal device 600 includes a representation by the drive editor DE designated (appointed) in the request Req from the user. For example, the controller 530 generates the control signal Sig1 that causes the display unit 640, the speaker unit 650, and the fragrance diffuser 670 of the terminal device 600 to perform a representation of talking with the user with use of an image, music, a place of interest, a fragrance, and the like used for the representation as subjects, and transmits the control signal Sig1 to the terminal device 600 through the communication unit 520. In a case where the representation in the terminal device 600 includes a representation by the drive editor, the request Req from the user includes information about interaction of the user with the drive editor in response to the representation. Thereafter, the controller 530 determines a representation on the basis of the interaction with the drive editor included in the request Req, for example. In a case where the request Req from the user includes setting information that is necessary for setting of a driving route (for example, route information 212a) and is inputted by the user, the controller 530 determines a driving route and a representation on the basis of the setting information included in the request Req, for example. Here, the “setting information” includes information about a departure point, an arrival point, or a via point. The “setting information” may be drive information obtained by driving by a person other than the user of the terminal device 600.

### (Terminal Device 600)

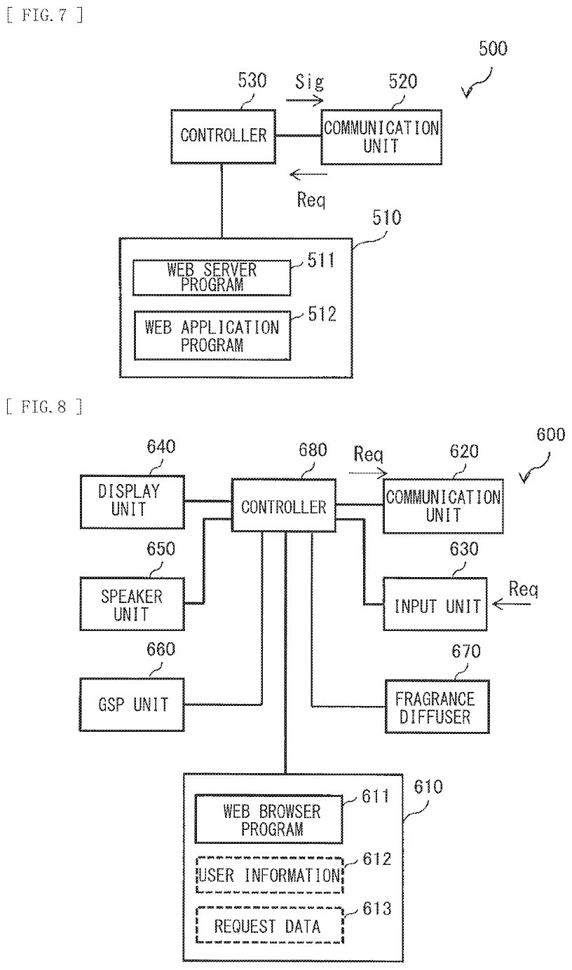

FIG. 8 illustrates a schematic configuration example of the terminal device 600. The terminal device 600 is a terminal device used by the user for navigation, and performs route guiding (navigation) and performs a representation that allows the user to have fun while traveling on the basis of the control signal Sig1 received from the web server device 500a or a control signal Sig2 obtained by performing predetermined processing on the control signal Sig1. The control signal Sig2 corresponds to a specific example of a “second control signal” of the present technology. The terminal device 600 includes, for example, a storage unit 610, a communication unit 620, an input unit 630, the display unit 640, the speaker unit 650, a GPS unit 660, the fragrance diffuser 670, and a controller 680. The controller 680 corresponds to a specific example of “an acceptance unit and a transmitter in a navigation information acceptance device” of the present technology.

The input unit 630 includes a keyboard, a touch panel, and the like. The display unit 640 performs display on the basis of an image signal inputted from the controller 680. The speaker unit 650 performs audio output on the basis of an audio signal inputted from the controller 680. On the basis of information received from a satellite, the GPS unit 660 derives position information and time information, and outputs the position information and the time information to the controller 680. The fragrance diffuser 670 releases a fragrance on the basis of a control signal inputted from the controller 680. The storage unit 610 stores programs and the like (for example, a web browser program 611 and an operating system) to be executed by the controller 680. The storage unit 610 stores user information 612 and request data 613.

The controller 680 includes a processor, and executes the web browser program 611, the operating system, and the like stored in the storage unit 610. The communication unit 620 communicates with other devices (such as the web server device 500) in the navigation system 1 through the network 100. A user interface (the display unit 640) in the terminal device 600 is implemented, for example, by processing an application (for example, html data) obtained from the web server device 500 by the web browser program 611.

For example, the controller 680 accepts the request Req as request data 613 from the user. The request Req from the user includes, for example, designation (appointment) of the drive editor DE, designation of the navigation information 212A, a request for adjustment to the navigation information 212A, a request to leave driving to the drive editor DE, or the like. The controller 680 accepts information about a situation, a mood, or a preference of the user as the request Req during driving, for example.

For example, the controller 680 transmits the accepted request Req from the user to the web server device 500. For example, the controller 680 transmits the accepted request Req together with the position information and the time information obtained by the GPS unit 660 to the web server device 500 through the communication unit 620. The position information obtained by the GPS unit 660 includes, for example, route information including a departure point, an arrival point, and a via point. The controller 680 receives, from the web server device 500, for example, the control signal Sig1 that causes the terminal device 600 to perform a representation determined on the basis of the request Req accepted from the user.

For example, the controller 680 performs a representation on the basis of the control signal Sig1 received from the web server device 500 or the control signal Sig2 obtained by performing the predetermined processing on the control signal Sig1. For example, the controller 680 outputs the control signal Sig1 or Sig2 to the display unit 640, the speaker unit 650, and the fragrance diffuser 670. For example, the controller 680 causes the display unit 640 of the terminal device 600 to display an image of a place of interest to be displayed on the basis of the control signal Sig1 or Sig2. For example, the controller 680 causes the speaker unit 650 of the terminal device 600 to output music appropriate to a place of interest on the basis of the control signal Sig1 or Sig2. For example, the controller 680 causes the display unit 640 and the speaker unit 650 of the terminal device 600 to output information about a place of interest to which a “Like” point is given on the basis of the control signal Sig1 or Sig2. For example, the controller 680 causes the fragrance diffuser 670 of the terminal device 600 to output a fragrance appropriate to the characteristics of the drive editor DE on the basis of the control signal Sig1 or Sig2.

For example, the controller 680 causes the display unit 640, the speaker unit 650, and the fragrance diffuser 670 to perform a representation by the drive editor designated in the request Req from the user on the basis of the control signal Sig1 or Sig2. For example, the controller 680 causes the display unit 640, the speaker unit 650, and the fragrance diffuser 670 to perform a representation of talking with the user with use of image, music, a place of interest, a fragrance, and the like used for the representation as subjects on the basis of the control signal Sig1 or Sig2.

### (Terminal Device 700)

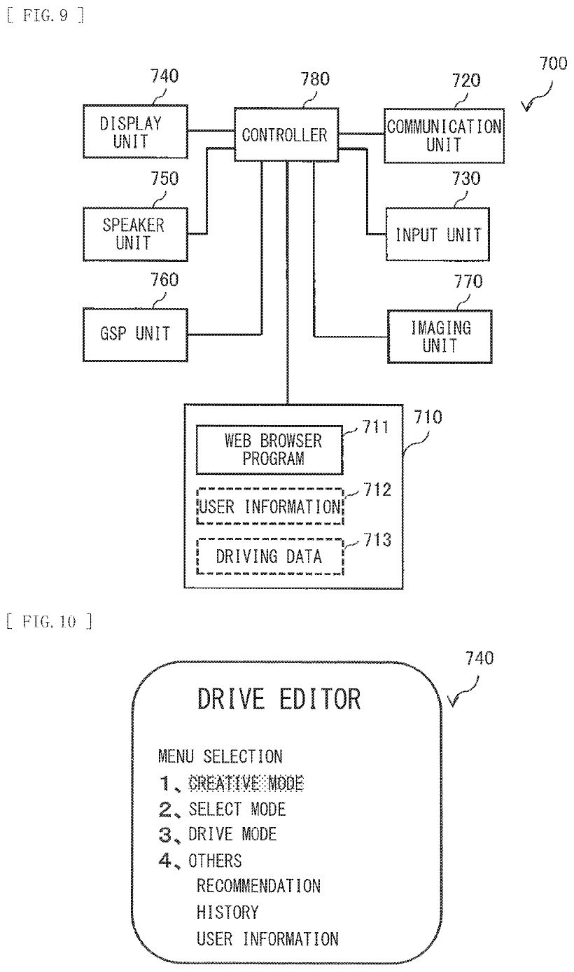

FIG. 9 illustrates a schematic configuration example of the terminal device 700. The terminal device 700 is a terminal device used by the user to register navigation information, and includes, for example, a storage unit 710, a communication unit 720, an input unit 730, a display unit 740, a speaker unit 750, a GPS unit 760, an imaging unit 770, and a controller 780.

The input unit 730 includes a keyboard, a touch panel, and the like. The display unit 740 performs display on the basis of an image signal inputted from the controller 780. The speaker unit 750 performs audio output on the basis of an audio signal inputted from the controller 780. On the basis of information received from a satellite, the GPS unit 760 derives position information and time information, and outputs the position information and time information to the controller 780. The imaging unit 770 performs imaging on the basis of an imaging start signal inputted from the user. The storage unit 710 stores programs (for example, the web browser program 711 and an operating system) to be executed by the controller 780. The storage unit 710 stores user information 712 and driving data 713.

The controller 780 includes a processor, and executes the web browser program 711, the operating system, and the like stored in the storage unit 710. The communication unit 720 communicates with other devices (such as the web server device 500) in the navigation system 1 through the network 100. A user interface (the display unit 740) in the terminal device 700 is implemented, for example, by processing an application (for example, html data) obtained from the web server device 500 by the web browser program 711.

### [Operation]

### (Creative Mode)

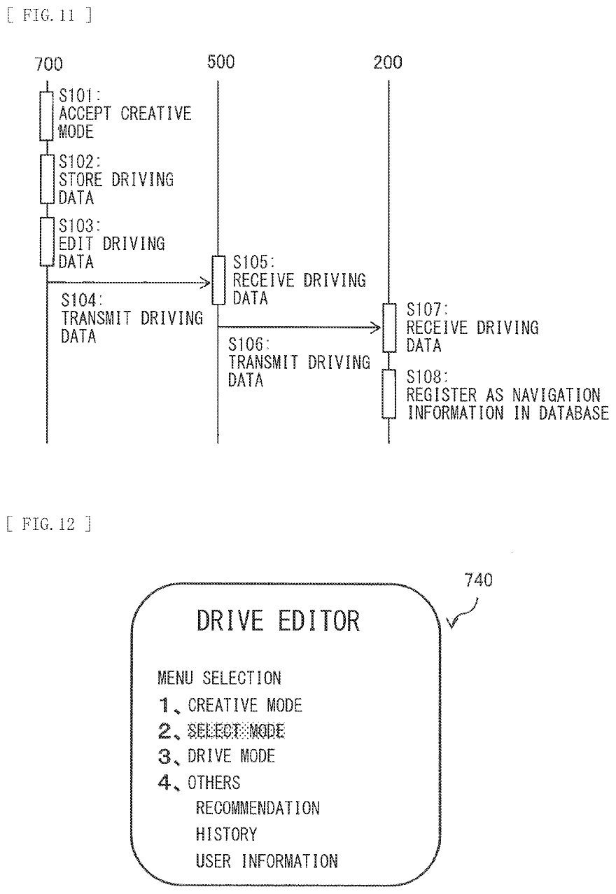

Next, description is given of a procedure of registering the navigation information 212A by the user. FIG. 10 illustrates an example of a user interface displayed on the display unit 740 of the terminal device 700. FIG. 11 illustrates an example of the procedure of registering the navigation information 212A in the navigation system 1.

The user interface illustrated in FIG. 10 is implemented by processing an application (for example, html data) obtained from the web server device 500 by the web browser program 711. Menu selection is displayed on the user interface illustrated in FIG. 10. For example, various major items such as “1. creative mode”, “2. select mode”, “3. drive mode” and “4. others” are displayed in the menu selection. In the “4. others”, various sub-items such as recommendation, history, and user information are displayed, for example.

The creative mode refers to a mode for allowing the user to register the navigation information 212A. The select mode refers to a mode for allowing the user to select (for example, purchase) one or more pieces of navigation information 212A from among a plurality of pieces of navigation information 212A registered in the data server device 200. The drive mode refers to a mode for selecting, for example, the drive editor DE or selecting one piece of navigation information 212A from among the one or more pieces of navigation information 212A selected in the select mode.

The user first inputs user information 712 to log in to the navigation system 1. The user information 712 includes, for example, a log-in ID, a password, and the like. The terminal device 700 (the controller 780) accepts the user information 712 inputted by the user, and determines whether or not the database 221 of the data server device 200 includes data coincident with the accepted user information 712. As a result, in a case where the database 221 includes the data coincident with the accepted user information 712, the terminal device 700 displays the user interface as illustrated in FIG. 10 on the display unit 740.

Next, the user selects the creative mode as illustrated in FIG. 10. The terminal device 700 then accepts the creative mode selected by the user (step S101). Thereafter, the terminal device 700 prompts the user to input the route information 212a including, for example, a departure point, an arrival point, and a via point, and accepts the route information 212a inputted by the user. The terminal device 700 further periodically accepts GPS data (position information and time information) as a portion of the route information 212a from the GPS unit 760, for example. The terminal device 700 further accepts, as representation information 212b, information about a situation, a mood, or a preference of the user associated with the route information 212a from the user during driving. At this time, the terminal device 700 accepts, for example, the route information 212a and the representation information 212b as the driving data 713, and stores the route information 212a and the representation information 212b in the storage unit 710 (step S102). The representation information 212b accepted from the user may include, for example, an image of a point of interest on a route, music suitable for the point of interest on the route, a “Like” point as rating on the point of interest on the route, a product sold at the point of interest on the route, a fragrance suitable for the point of interest on the route, and the like.

Next, for example, the user edits the driving data 713 as necessary (step S103). For example, after driving is completed, the user associates an image and a “Like” point with an optional point on the route. For example, after editing of the driving data 713 is completed, the user instructs the terminal device 700 to transmit the driving data 713. The terminal device 700 then transmits the driving data 713 to the web server device 500 (step S104). Upon receiving the driving data 713 from the terminal device 700, the web server device 500 transmits the received driving data 713 to the data server device 200 (steps S105 and S106). Upon receiving the driving data 713 from the web server device 500, the data server device 200 registers the received driving data 713 as the navigation information 212A in the database 212 of the storage unit 210 (steps S107 and S108). Thus, registration of the navigation information 212A is completed.

### (Select Mode)

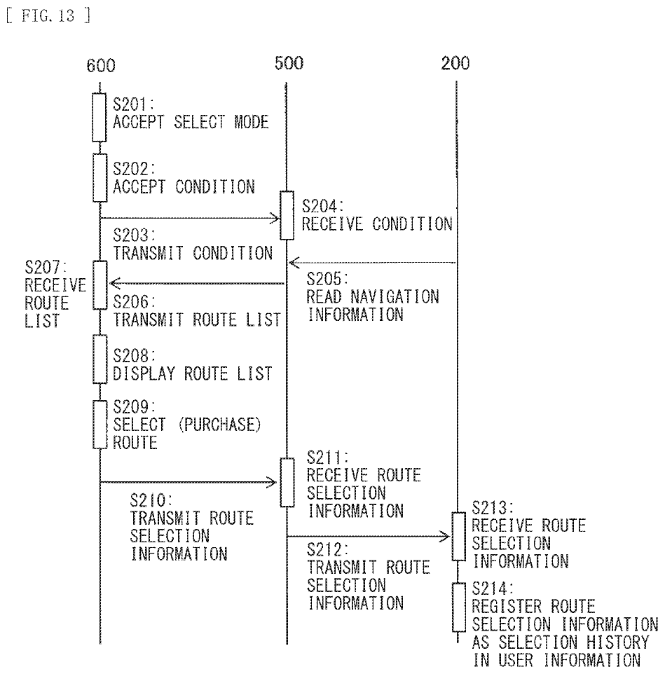

Next, description is given of a procedure of selecting (for example, purchasing) the navigation information 212A by the user. FIG. 12 illustrates an example of a user interface displayed on the display unit 640 of the terminal device 600. FIG. 13 illustrates an example of a procedure of selecting (for example, a procedure of purchasing) the navigation information 212A in the navigation system 1.

The user interface illustrated in FIG. 12 is implemented by processing an application (for example, html data) obtained from the web server device 500 by the web browser program 611. Menu selection similar to that of FIG. 10 is displayed on the user interface illustrated in FIG. 12. It is to be noted that a user of the terminal device 700 and a user of the terminal device 600 may be the same person or may be different from each other.

The user first inputs the user information 612 to log in to the navigation system 1. The user information 612 includes, for example, a log-in ID, a password, and the like. The terminal device 600 (the controller 680) accepts the user information 612 inputted by the user, and determines whether or not the database 221 of the data server device 200 includes data coincident with the accepted user information 612. As a result, in a case where the database 221 includes the data coincident with the accepted user information 612, the terminal device 600 displays the user interface as illustrated in FIG. 12 on the display unit 640. It is to be noted that in a case where the user has already logged in, it is not necessary for the user to input the user information 612.

Next, the user selects the select mode as illustrated in FIG. 12. The terminal device 600 accepts the select mode selected by the user (step S201). Thereafter, the terminal device 600 prompts the user to input a condition for selecting (for example, purchasing) the navigation information 212A, for example, and accepts the condition inputted by the user (step S202). The terminal device 600 further transmits the accepted condition to the web server device 500, for example (step S203).

The web server device 500 receives the condition from the terminal device 600 (step S204). The web server device 500 determines whether or not the database 212 of the data server device 200 includes data coincident with the received condition. As a result, in a case where the database 212 includes the data coincident with the condition, the web server device 500 reads one or more pieces of navigation information 212A coincident with the condition from the database 212 (step S205). The web server device 500 transmits a route list corresponding to the read one or more pieces of navigation information 212A to the terminal device 600 (step S206). The route list includes, for example, route names included in the respective pieces of navigation information 212A.

The terminal device 600 receives the route list from the web server device 500 (step S207). The terminal device 600 causes the display unit 640 to display the received route list (step S208). The user selects (for example, purchases) one or more routes from the route list displayed on the display unit 640 (step S209). The terminal device 600 transmits information (route selection information) about the selected (for example, purchased) one or more routes to the web server device 500 (step S210). The web server device 500 receives the route selection information from the terminal device 600 (S211). The web server device 500 transmits the received route selection information to the data server device 200 (step S212). The data server device 200 receives the route selection information from the web server device 500 (step S213). The data server device 200 registers the received route selection information as a selection history (for example, a purchase history) in the user information 221A of the storage unit 210 (step S214). Thus, selection (for example, purchase) of the navigation information 212A is completed.

### (Drive Mode)

Next, description is given of acceptance of the request Req from the user and driving on the basis of the accepted request Req from the user.

The request Req from the user may include, for example, designation of a drive editor, designation of the navigation information 212A, a request for adjustment to the navigation information 212A, a request to leave driving to the drive editor DE, or the like. Here, the “request for adjustment” includes, for example, information about a situation, a mood, or a preference of the user. The “situation of the user” in the “request for adjustment” includes information about a schedule or spare time of the user.

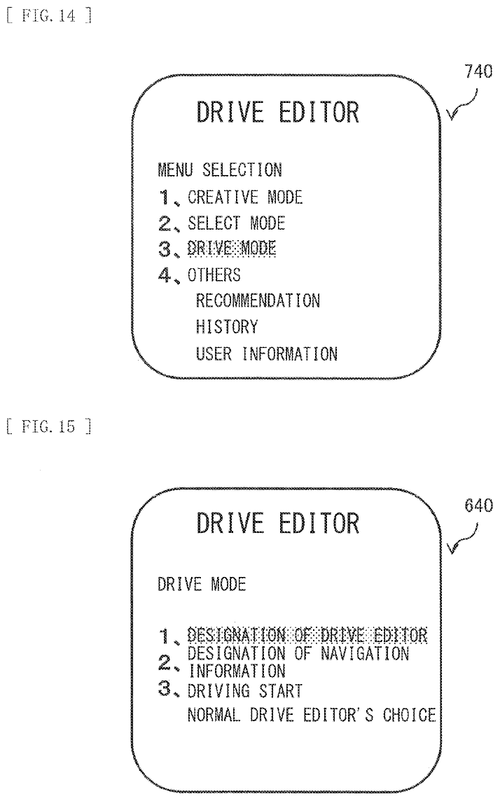

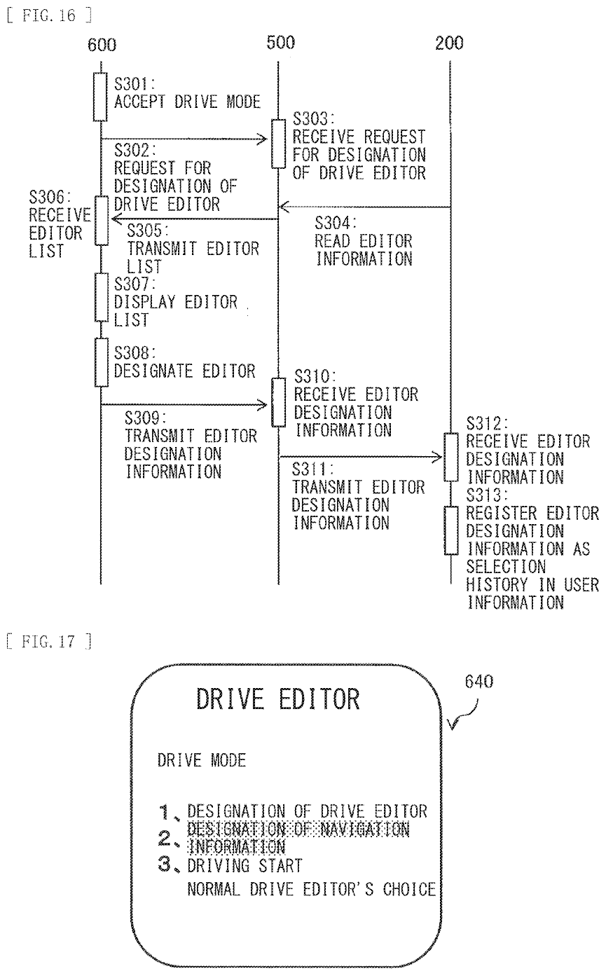

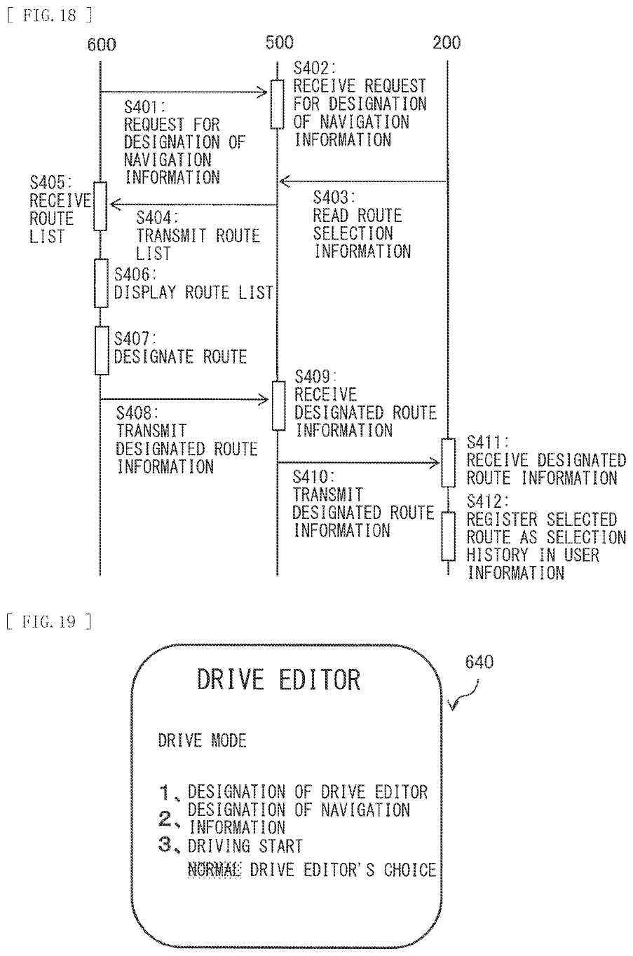

FIGS. 14, 15, and 17 illustrate examples of user interfaces displayed on the display unit 640 of the terminal device 600. FIG. 16 illustrates an example of a procedure of designating the drive editor in the navigation system 1. FIG. 18 illustrates an example of a procedure of designating the navigation information 212A in the navigation system 1.

The user interfaces illustrated in FIG. 14, FIG. 15, and FIG. 17 are implemented by processing an application (for example, html data) obtained from the web server device 500 by the web browser program 611. Menu selection similar to that of FIG. 10 is displayed on the user interface illustrated in FIG. 14. FIGS. 15 and 17 illustrate examples of a user interface displayed on the display unit 640 in a case where the drive mode is selected in the user interface illustrated in FIG. 14.

First, description is given of the procedure of designating (appointing) the drive editor DE.

The user first inputs the user information 612 to log in to the navigation system 1. The user information 612 includes, for example, a log-in ID, a password, and the like. The terminal device 600 (the controller 680) accepts the user information 612 inputted by the user, and determines whether or not the database 221 of the data server device 200 includes data coincident with the accepted user information 612. As a result, in a case where the database 221 includes the data coincident with the accepted user information 612, the terminal device 600 causes the display unit 640 to display the user interface as illustrated in FIG. 14. In a case where the user has already logged in, it is not necessary for the user to input the user information 612.

Next, the user selects the drive mode, for example, as illustrated in FIG. 14. The terminal device 600 accepts the drive mode selected by the user (step S301). Upon selecting the drive mode, for example, as illustrated in FIG. 15, the terminal device 600 causes the display unit 640 to display three major items of “designation of drive editor”, “designation of navigation information”, and “driving start”, and items of “normal” and “drive editor's choice” as sub-items of “driving start”. For example, the user selects the “designation of drive editor” from the three major items displayed on the display unit 640. For example, in a case where the “designation of drive editor” is selected, the terminal device 600 transmits a request for designation of the drive editor DE to the web server device 500 (step S302).

The web server device 500 receives, for example, the request for designation of the drive editor from the terminal device 600 (step S303). Then, for example, the web server device 500 reads the editor information 219A from the storage unit 210 of the data server device 200, and transmits an editor list corresponding to the read editor information 219A to the terminal device 600 (steps S304 and S305). The editor list includes, for example, names and characteristics of the respective drive editors DE included in the editor information 219A.

For example, the terminal device 600 receives the editor list from the web server device 500 (step S306). For example, the terminal device 600 causes the display unit 640 to display the received editor list (step S307). The user designates one drive editor DE from the editor list displayed on display unit 640 (step S308). For example, the terminal device 600 transmits information (editor designation information) about the drive editor designated by the user to the web server device 500 (step S309).

For example, the web server device 500 receives the editor designation information from the terminal device 600 (step S310). The web server device 500 transmits the received editor designation information to the data server device 200 (step S311). The data server device 200 receives the editor designation information from the web server device 500 (step S312). The data server device 200 registers the received editor designation information as a selection history in the user information 221A of the storage unit 210 (step S313). Thus, designation of the drive editor is completed.

Next, description is given of the procedure of designating the navigation information 212A.

The user first inputs the user information 612 to log in to the navigation system 1. The user information 612 includes, for example, a log-in ID, a password, and like. The terminal device 600 accepts the user information 612 inputted by the user, and determines whether or not the database 221 of the data server device 200 includes data coincident with the accepted user information 612. As a result, in a case where the database 221 includes the data coincident with the accepted user information 612, the terminal device 600 causes the display unit 640 to display the user interface as illustrated in FIG. 14. It is to be noted that in a case where the user has already logged in, it is not necessary for the user to input the user information 612.

Next, for example, as illustrated in FIG. 17, the user selects “designation of navigation information” from the three major items displayed on the display unit 640. For example, in a case where the “designation of navigation information” is selected, the terminal device 600 transmits a request for designation of navigation information to the web server device 500 (step S401).

For example, the web server device 500 receives the request for designation of navigation information from the terminal device 600 (step S402). The web server device 500 then reads one or more pieces of route selection information from, for example, the selection history included in the user information 221A of the data server device 200 (step S403). For example, the web server device 500 transmits a route list including the read one or more pieces of route selection information to the terminal device 600 (step S404).

For example, the terminal device 600 receives the route list from the web server device 500 (step S405). For example, the terminal device 600 causes the display unit 640 to display the received route list (step S406). The user designates one route from the route list displayed on the display unit 640 (step S407). For example, the terminal device 600 transmits information (designated route information) about the route designated by the user to the web server device 500 (step S408).

For example, the web server device 500 receives the designated route information from the terminal device 600 (step S409). The web server device 500 transmits the received designated route information to the data server device 200 (step S410). The data server device 200 receives the designated route information from the web server device 500 (step S411). The data server device 200 registers the received designated route information as a selection history in the user information 221A of the storage unit 210 (step S412). Thus, designation of the navigation information 212A is completed.

Next, description is given of a procedure of guiding a route in the navigation system 1.

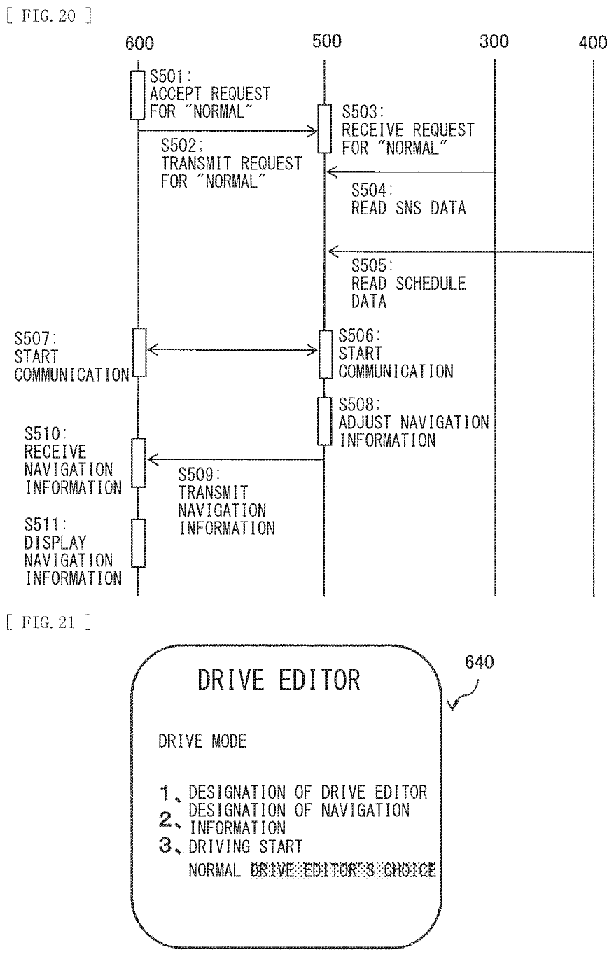

FIG. 19 illustrates an example of a user interface displayed on the display unit 640 of the terminal device 600. FIG. 20 illustrates an example of the procedure of guiding the route in the navigation system 1.

The user interface illustrated in FIG. 19 is implemented by processing an application (for example, html data) obtained from the web server device 500 by the web browser program 611. Menu selection similar to that of FIG. 17 is displayed on the user interface illustrated in FIG. 19. FIG. 19 illustrates an example of a user interface displayed on the display unit 640 in a case where the drive mode is selected in the user interface illustrated in FIG. 14.

As illustrated in FIG. 19, for example, the user first selects the “normal” that is one of the sub-items of the “3. driving start”. The terminal device 600 receives a request for the “normal” by the user (step S501). In a case where the “normal” is selected, for example, the terminal device 600 prompts the user to input a request, and stores the inputted request as the request data 613 in the storage unit 610 as necessary. The request includes, for example, information about a situation, a mood, or preference of the user. Here, the situation of the user includes information about a schedule or spare time of the user. For example, the terminal device 600 transmits the request for the “normal” to the web server device 500 (step S502).

For example, the web server device 500 receives the request for the “normal” from the terminal device 600 (step S503). For example, the web server device 500 further receives the request data 613 together with the request for the “normal” as necessary.

In a case where the web server device 500 receives the request data 613, the web server device 500 determines a representation that allows the user to have fun while traveling on the basis of the received request data 613, for example. The web server device 500 generates the control signal Sig1 that causes the terminal device 600 to perform the determined representation, and outputs the signal Sig1 to the terminal device 600.

In a case where the web server device 500 receives the request data 613, the web server device 500 may perform, for example, the following processing. In the case where the web server device 500 receives the request data 613, the web server device 500 may perform, for example, the following processing. For example, the web server device 500 first reads, from the storage unit 210 of the SNS server device 300, information that enables adjustment to the designated navigation information 212A and meets the request data 613 (step S504). For example, the web server device 500 also determines whether or not the user data 411A corresponding to the user is included in the database 411 stored in the storage unit 410 of the schedule server device 400. As a result, in a case where the user data 411A corresponding to the user is included in the database 411, the web server device 500 reads, for example, current and subsequent schedules from the schedule data 412A associated with the user data 411A corresponding to the user (step S505).

Thereafter, for example, the web server device 500 calls the designated drive editor DE. For example, the web server device 500 reads information about the designated drive editor DE (the editor information 219A) from the database 219 of the data server device 200, and starts the drive editor DE with use of the read editor information 219A. For example, the web server device 500 starts communication with the user by the called drive editor DE (step S506).

At this time, for example, the terminal device 600 starts communication between the designated drive editor DE and the user with use of the display unit 640, the speaker unit 650, and the fragrance diffuser 670 (step S507). For example, the web server device 500 performs adjustment to the designated navigation information 212A on the basis of a result of the communication with the user with use of information read from the SNS server device 300 and the schedule server device 400 and the request data 613 (step S508). For example, the web server device 500 transmits the navigation information 212A (the control signal Sig1 that causes the terminal device 600 to perform a representation) to the terminal device 600 after the adjustment is completed or while the adjustment is performed (step S509). For example, the terminal device 600 receives the navigation information 212A from the web server device 500 (step S510). For example, the terminal device 600 causes the display unit 640 to display the received navigation information 212A (step S511). At this time, for example, the terminal device 600 guides a route on the basis of the route information 212a, and performs a representation while traveling on the basis of the representation information 212b. Thus, the route is guided by the drive editor DE.

Next, description is given of another example of the procedure of guiding the route in the navigation system 1.

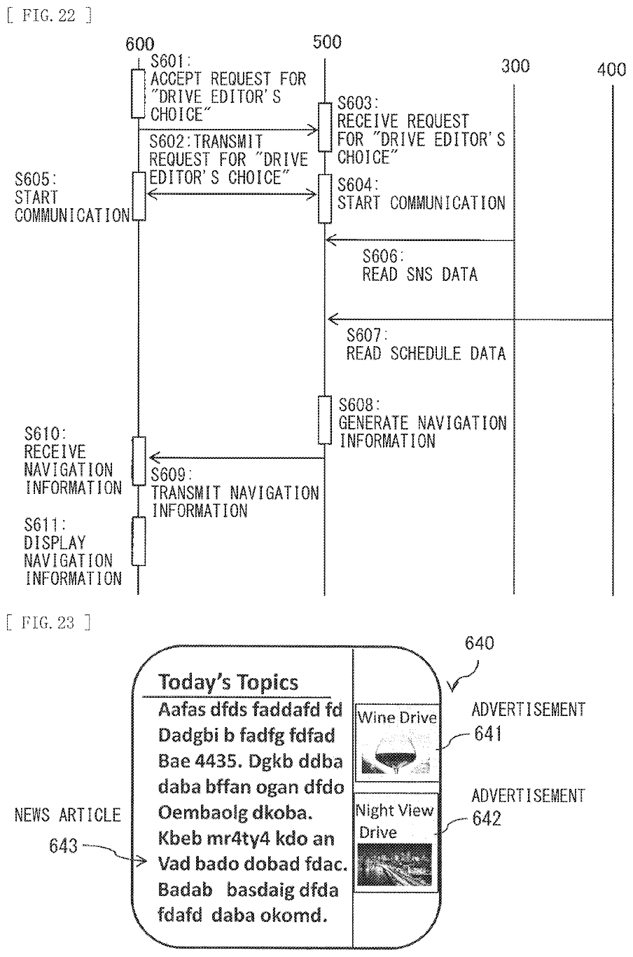

FIG. 21 illustrates an example of a user interface displayed on the display unit 640 of the terminal device 600. FIG. 22 illustrates an example of the procedure of guiding the route in the navigation system 1.

The user interface illustrated in FIG. 21 is implemented by processing an application (for example, html data) obtained from the web server device 500 by the web browser program 611. Menu selection similar to that of FIG. 17 is displayed on the user interface illustrated in FIG. 21. FIG. 21 illustrates an example of the user interface displayed on the display unit 640 in a case where the drive mode is selected in the user interface illustrated in FIG. 14.

For example, as illustrated in FIG. 21, the user first selects the “drive editor's choice” that is one of the sub-items of the “3. driving start”. The terminal device 600 receives a request for the “drive editor's choice” by the user (step S601). For example, the terminal device 600 transmits the received request for the “drive editor's choice” to the web server device 500 (step S602). For example, the web server device 500 receives the request for the “drive editor's choice” from the terminal device 600 (step S603). For example, the web server device 500 then calls the designated drive editor DE and starts communication with the user by the called drive editor DE (step S604). At this time, for example, the terminal device 600 starts communication between the designated drive editor DE and the user with use of the display unit 640, the speaker unit 650, and the fragrance diffuser 670 (S S605).

For example, the web server device 500 reads necessary information from the storage unit 210 of the SNS server device 300 in response to a result (for example, a request from the user) of the communication between the drive editor DE and the user (step S606). For example, the web server device 500 also determines whether or not the user data 411A corresponding to the user is included in the database 411 stored in the storage unit 410 of the schedule server device 400. As a result, in a case where the user data 411A corresponding to the user is included in the database 411, the web server device 500 reads, for example, current and subsequent schedules from the schedule data 412A associated with the user data 411A corresponding to the user (step S607). Thereafter, for example, the web server device 500 performs communication between the drive editor DE and the users on the basis of contents of the read schedules. For example, the web server device 500 generates the navigation information 212A (the control signal Sig1 that causes the terminal device 600 to perform a representation) on the basis of the communication between the drive editor DE and the user (for example, a request from the user) (step S608).

For example, the web server device 500 transmits the generated navigation information 212A to the terminal device 600 (step S609). For example, the terminal device 600 receives the navigation information 212A from the web server device 500 (step S610). For example, the terminal device 600 causes the display unit 640 to display the received navigation information 212A (step S611). At this time, for example, the terminal device 600 guides a route on the basis of the route information 212a, and performs a representation while traveling on the basis of the representation information 212b. Thus, the route is guided by the drive editor DE.

Next, description is given of a method of calling the drive editor DE through an advertisement.

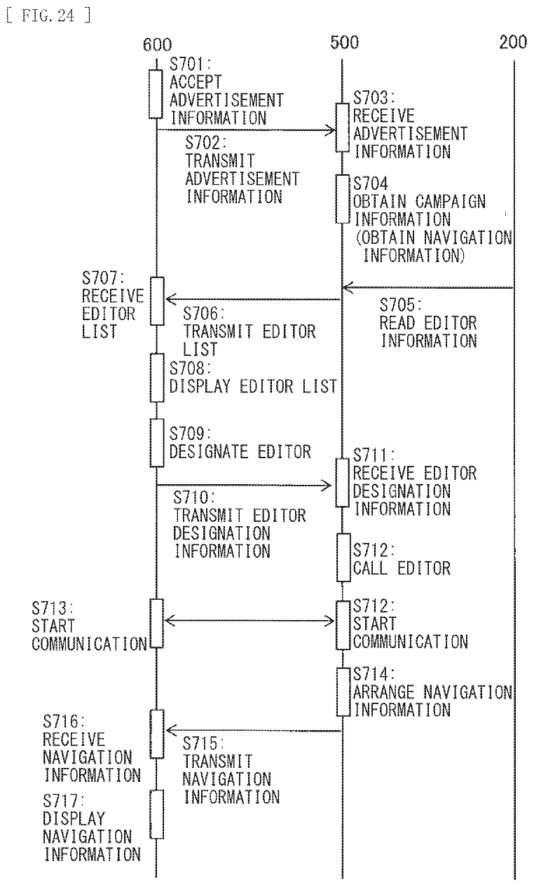

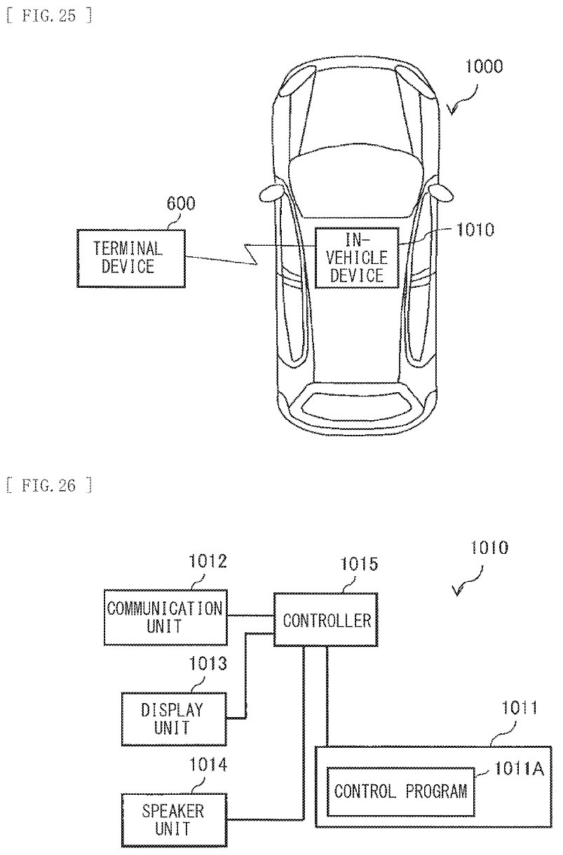

FIG. 23 illustrates an example of a user interface displayed on the display unit 640 of the terminal device 600. FIG. 24 illustrates an example of a procedure of calling the drive editor DE through an advertisement. FIG. 23 illustrates, as an example, a state in which two advertisements 641 and 642 and a news article 643 are displayed.

The user first selects, for example, the advertisement 641 illustrated in FIG. 23. Then, the terminal device 600 receives information (advertisement information) about the advertisement selected by the user (step S701). The advertisement information includes, for example, a URL (Uniform Resource Locator) of an advertisement site, and the like. The advertisement information corresponds to the request Req from the user. For example, the terminal device 600 transmits the received advertisement information to the web server device 500 (step S702). For example, the web server device 500 receives the advertisement information from the terminal device 600 (step S703). For example, the web server device 500 accesses the URL included in the received advertisement information, and obtains campaign information stored in the URL (step S704). The campaign information includes, for example, the navigation information 212A that advertises an advertised product. At this time, the navigation information 212A includes the route information 212a set for the advertisement selected in the request Req and a representation (the representation information 212b) set for the advertisement selected in the request Req.

For example, in a case where the web server device 500 obtains the campaign information, the web server device 500 executes the “designation of drive editor” in the drive mode. Specifically, for example, the web server device 500 reads the editor information 219A from the storage unit 210 of the data server device 200, and transmits an editor list corresponding to the read editor information 219A to the terminal device 600 (steps S705 and S706). The editor list includes, for example, names and characteristics of the drive editors DE included in the editor information 219A.

For example, the terminal device 600 receives the editor list from the web server device 500 (step S707). For example, the terminal device 600 causes the display unit 640 to display the received editor list (step S708). The user designates one drive editor DE from the editor list displayed on display unit 640 (step S709). For example, the terminal device 600 transmits information (editor designation information) about the drive editor designated by the user to the web server device 500 (step S710).

For example, the web server device 500 receives the editor designation information from the terminal device 600 (step S711). For example, the web server device 500 calls the drive editor DE with use of the editor information 219A corresponding to the received editor designation information (step S712). For example, the web server device 500 starts communication with the user by the called drive editor DE (step S713). At this time, for example, the terminal device 600 starts communication between the designated drive editor DE and the user with use of the display unit 640, the speaker unit 650, and the fragrance diffuser 670.

For example, the web server device 500 performs adjustment to the navigation information 212A as necessary through the communication between the designated drive editor DE and the user (step S714). For example, the web server device 500 transmits the navigation information 212A to the terminal device 600 after the adjustment is completed or while the adjustment is performed (step S715). For example, the terminal device 600 receives the navigation information 212A from the web server device 500 (step S716). For example, the terminal device 600 causes the display unit 640 to display the received navigation information 212A (step S717). At this time, for example, the terminal device 600 guides a route on the basis of the route information 212a, and performs a representation while traveling on the basis of the representation information 212b. Thus, the drive editor DE is called through the advertisement, and the route is guided by the called drive editor DE.

### [Effects]

Next, description is given of effects of the navigation system 1 according to the present embodiment.

In recent years, in-vehicle or portable navigation devices have become popular. Some mobile phones and so-called smartphones have a positioning function and are usable as navigation devices. As a frequent situation in which a navigation device is used, the navigation device is used to search for a route from a fixed location to a fixed destination such as a route from home to an office or from an office to home. For this reason, the existing navigation devices are designed to reliably guide a user to the destination, and is not suitable for having fun while traveling.

In contrast, in the present embodiment, a representation that allows the user to have fun while traveling is determined on the basis of the request Req received from the user, and the control signal Sig1 that causes the terminal device 600 to perform the determined representation is generated, and outputted to the terminal device 600. This makes it possible for the terminal device 600 to perform the representation that allows the user to have fun while traveling. As a result, the representation in the terminal device 600 makes it possible for the user to have fun while traveling.

In addition, in the present embodiment, the request Req from the user includes information about a situation, a mood, or a preference of the user. This makes it possible to perform a representation corresponding to the situation, the mood, or the preference of the user. Accordingly, the representation by the terminal device 600 makes it possible for the user to have fun while traveling.

Further, in the present embodiment, in the request Req from the user, the situation of the user includes information about a schedule or spare time of the user. This makes it possible to perform a representation corresponding to the schedule or the spare time of the user. Accordingly, the representation in the terminal device 600 makes it possible for the user to have fun while traveling.

In addition, in the present embodiment, in a case where the request Req from the user includes information about the drive editor designated by the user, it is possible to perform a representation by the drive editor DE designated in the request Req from the user. As a result, the drive editor performs a representation suitable for the preference of the user. Accordingly, the representation in the terminal device 600 makes it possible for the user to have fun while traveling.

Further, in the present embodiment, in a case where the representation in the terminal device 600 includes a representation by the drive editor, the request Req from the user includes information about interaction with the drive editor performed by the user in response to the representation. As a result, the drive editor DE performs a representation suitable for the preference of the user. Accordingly, the representation in the terminal device 600 makes it possible for the user to have fun while traveling.

In addition, in the present embodiment, in a case where the request Req from the user includes information about an advertisement selected by the user, the representation in the terminal device 600 includes a representation set for the advertisement selected in the request from the user. As a result, the drive editor DE performs a representation suitable for the preference of the user. Accordingly, the representation in the terminal device 600 makes it possible for the user to have fun while traveling.

Further, in the present embodiment, in a case where the request Req from the user includes setting information necessary for setting of a driving route (for example, the route information 212a) that is inputted by the user, it is possible to perform setting of the driving route and a representation on the basis of the setting information included in the request Req from the user. As a result, the drive editor DE performs a representation suitable for the preference of the user. Accordingly, the representation in the terminal device 600 makes it possible for the user to have fun while traveling.

In addition, in the present embodiment, in a case where the setting information (for example, the route information 212a) described above is information obtained by driving by a person other than the user, it is possible to drive a route that the user of the terminal device 600 does not often select. This makes it possible for the user of the terminal device 600 to prevent driving from becoming routine, which makes it possible for the user to have fun while traveling.

Further, in the present embodiment, a plurality of pieces of navigation information 212A including the route information 212a and the representation information 212b is stored in the storage unit 210 of the data server device 200, and the navigation information 212A corresponding to the request Req from the terminal device 600 is read from among the plurality of pieces of navigation information 212A stored in the storage unit 210. Then, the read navigation information 212A is transmitted to the terminal device 600. This makes it possible for the terminal device 600 to perform a representation that allows the user to have fun while traveling. Accordingly, the representation in the terminal device 600 makes it possible for the user to have fun while traveling.

In addition, in the present embodiment, during driving, information about a situation, a mood, or a preference of the user is accepted as the request Req from the user. Then, the accepted request Req is transmitted together with the route information 212a to the web server device 500. As a result, the web server device 500 determines a representation corresponding to the request Req, which makes it possible for the terminal device 600 to perform a representation that allows the user to have fun while traveling. Accordingly, the representation in the terminal device 600 makes it possible for the user to have fun while traveling.

### 2. MODIFICATION EXAMPLES

### Modification Example A

In the foregoing embodiment, in a case where information about an arrival point, a via point, or a via route is not included in the request Req, the web server device 500 (the controller 530) may conceal an arrival point, a via point, or a via route that is determined on the basis of the request Req for a predetermined period of time without unconditionally notifying the terminal device 600 (the user) of the arrival point, the via point, or the via route. Such a case allows the user to feel excited about not knowing the arrival point, the via point, or the via route, which makes it possible to perform a representation that allows the user to have fun while traveling. Accordingly, the representation in the terminal device 600 makes it possible for the user to have fun while traveling.

### Modification Example B

In the foregoing embodiment, the terminal device 600 may be an in-vehicle device of a mobile body 1000. In this case, it is not necessary for the user to prepare the terminal device 600 separately from the in-vehicle device of the mobile body 1000, which makes it possible to prevent the user from losing an opportunity of a representation due to not carrying the terminal device 600. [Modification Example C]

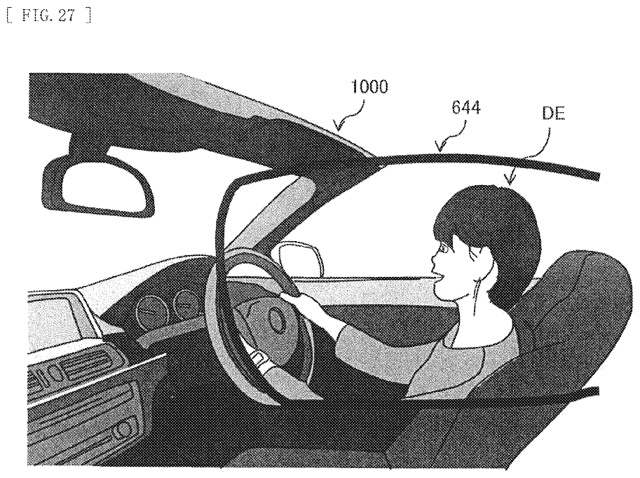

In the foregoing embodiment, for example, as illustrated in FIG. 25, the terminal device 600 may be provided separately from an in-vehicle device 1010 of the mobile body 1000, and may be allowed to communicate with the in-vehicle device 1010. In this case, the in-vehicle device 1010 includes, for example, a storage unit 1011, a communication unit 1012, a display unit 1013, a speaker unit 1014, and a controller 1015, as illustrated in FIG. 26.

The storage unit 1011 stores programs and the like (for example, a control program 1011A) to be executed by the controller 1015. The control program 1011A executes all or some of functions of the web application program 512. The communication unit 1012 communicates with the terminal device 600 through a network. The display unit 1013 performs display on the basis of an image signal inputted from the controller 1015. The speaker unit 1014 performs audio output on the basis of an audio signal inputted from the controller 1015. The controller 1015 includes a processor, and executes the control program 1011A and the like stored in the storage unit 1011.

In the present modification example, the terminal device 600 is allowed to communicate with the in-vehicle device 1010. This makes it possible for the in-vehicle device 1010 to execute some of the functions of the web application program 512, thereby reducing an operation load of the web server device 500.

In addition, in the present modification example, after the terminal device 600 and the in-vehicle device 1010 start communication with each other, the terminal device 600 (the controller 680) may output the control signal Sig1 or Sig2 to the display unit 640 or the speaker unit 650 and also output the control signal Sig1 or Sig2 to the in-vehicle device 1010 through the communication unit 620 simultaneously. At this time, the terminal device 600 (the controller 680) outputs the control signal Sig1 or Sig2 to the display unit 640 or the speaker unit 650, and also outputs the signal Sig1 or Sig2 to the in-vehicle device 1010 simultaneously. In the present modification example, the controller 680 corresponds to a specific example of “a receiver and an output unit in a navigation information acceptance device” of the present technology.

In such a case, the controller 1015 outputs the control signal Sig1 or Sig2 to the display unit 1013 or the speaker unit 1014, which makes it possible for the display unit 101 or the speaker unit 1014 to also execute, without change, an operation that is executed by the display unit 640 or the speaker unit 650. In other words, display by the display unit 640 and display by the display unit 1013 are synchronized with each other, and output from the speaker unit 650 and output from the speaker unit 1014 are synchronized with each other. This makes it possible for the user to continue experiencing a representation by the drive editor without interruption of the representation when the user gets in the mobile body 1000.

### Modification Example D

In the foregoing embodiment and the modification examples thereof, the terminal device 600 (the controller 680) may determine a representation that allows the user to have fun while traveling on the basis of the accepted request Req. In this case, the terminal device 600 (the controller 680) generates the control signal Sig1 for executing the determined representation (or a representation corresponding to the request Req). The terminal device 600 (the controller 680) may further output the generated control signal Sig1 or the control signal Sig2 obtained by performing predetermined processing on the control signal Sig1 to various devices (for example, the display unit 640, the speaker unit 650, the fragrance diffuser 670, etc.). In this case, the terminal device 600 corresponds to a specific example of a “navigation device” of the present technology. In addition, in this case, various devices (for example, the display unit 640, the speaker unit 650, the fragrance diffuser 670, etc.) in the terminal device 600 correspond to a specific example of a “representation device” of the present technology.

### 3. EXAMPLES

Next, description is given of examples of the navigation system 1 according to the foregoing embodiment and the modification examples thereof.

### Example 1

In the navigation system 1 according to the present example, it is assumed that the terminal device 600 (the controller 680) has a function of autonomously driving the mobile body 1000. Further, in the present example, the terminal device 600 (the controller 680) includes VR (Virtual Reality) spectacles 644 as one function of the display unit 640. The controller 680 outputs the control signal Sig1 or Sig2 to the VR spectacles 644. The VR spectacles 644 display information (for example, a virtual drive editor DE, etc.) generated on the basis of the control signal Sig1 or Sig2 from the controller 680 while superimposing the information on a real space. FIG. 27 illustrates, as an example, a state in which the user is looking at the virtual drive editor DE through the VR spectacles 644.

Takashi was a 38-year-old single man, and was an energy-related sales manager of a major trading company.

Takashi finished off a week of work, and finally it was time to go home. Takashi refused an invitation for a drinking party from a junior colleague today, and was looking forward to a relaxing time after returning home. Takashi arrived at Yurakucho. Takashi took out my smartphone as usual on a subway back home. When Takashi looked for a favorite wine, he noticed a small spot advertisement on a side of a screen, which was an advertisement of sparkling wine. An actress in the advertisement looked as if she was smiling at Takashi. Takashi looked at his watch, which showed 9:30 p.m. on Friday.

Takashi opened the advertisement and clicked [driving with wine] while saying, “Well, it's off tomorrow”. Takashi opened his favorite drive editor list, which was a link page to an autonomous driving service. The link page had recently been tied to alcohol advertisements.

Takashi had four favorite drive editors. The first one was Reina. In a memo section, “good-looking in in her mid-Ts” was written. The beginning of Reina's driving was impressive like drinking dry martini at a gulp. At the end of Reina's driving, Takashi got a good mood, and could fall asleep slowly. Takashi liked it. The second one was Dr. T, who was an attractive man in his late 40's having a gray stubble. Dr. T was always dressed in a well-tailored jacket. Dr. T's driving was also interesting. Dr. T claimed to be a doctor, which might be a reason that Dr. T started to treat worry or frustration kept in the depth of the mind of a passenger immediately after watching the passenger's expression in a rearview mirror. Takashi heard that doctor-style treatment using all of words, sounds, and scenery was popular among women, because the treatment made women refresh. Dr. T's driving started softly, and Dr. T made Takashi experience driving like slow night sky cruising.

The third one was Kenji, who was about 30 years old. Kenji seemed to have been a back dancer in a dance group in the past, and he had a good sense of music, rhythmical handling, and a technique of never getting caught by a red light. Music flowed into Takashi's body, and when Takashi got off a car, he had sense of incongruity in his ears as if he came out of a club, and his hot skin was cooled down by night air. Takashi liked such a feeling. The fourth one was Yuko, who was 35 years old. Yuko was full of mysteries. Yuko's lonely profile from the passenger's seat and reminiscences that Yuko occasionally talked about healed Takashi's mind for some reason. Yuko reminded Takashi of his ex-girlfriend who broke up with him five years ago, even though Yuko did not look like his ex-girlfriend.

Takashi was on the Tozai line back home from the office just after 9:30 p.m. on Friday.

While Takashi was rocked by a train from Tokyo Station, he unintentionally looked up at a hanging advertisement poster, and looked at a photograph of the Tokyo Tower illuminated orange at night in a business area of Tokyo. Takashi did not remember what the advertisement was for.

“Beautiful, nice,” Takashi looked at the photograph for a while. “I'd like to go to the Tokyo Tower,” Takashi inwardly muttered not even to himself. Takashi kept looking at the photograph.

When doors of the train opened at Kudanshita Station, Takashi jumped off the train, and selected Reina. “Just for a drink before going home.” Takashi lived in Koenji. It took another 30 minutes to Nakano Station by this subway. Ten minutes from the station to his apartment. If Takashi called his car now, his car should come to him in thirty minutes.

Takashi went up the stairs at Kudanshita Station, and entered a bar on the first floor of a building across a street. Takashi ordered wine and started to drink the wine slowly. Takashi took out his smartphone and clicked a PICK-UP button on a Reina's page. At the same time, the headlights of his car parked in an underground parking area of his apartment illuminated, and the instrument panel of his car was turned on. Reina started to find a route up to arrival time designated by Takashi by judging from his current location. Takashi started to play with his smartphone while enjoying dry-cured ham and cool white wine until 10:00 designated for pick-up time.

“I have no plan tomorrow, so ask Reina to take me to a two-hour trip?” Takashi started to answer some questions, while looking forward to how she was going to entertain him today.

Reina: “What would you like to be if you were to be reborn?”

Takashi: “maybe a doctor.”
Reina: “If your girlfriend cheats on you, what will you do?”
Takashi: “What? My ex-girlfriend cheated on me five years ago.”
Reina: “Which do you like better, lean meat or meat on bones?”
Takashi: “What? Is this question related to the previous one?”
Reina: “What if you were in an unknown country when you awoke, and you didn't understand a language of the country?”
Takashi: “well, I might have a drink first, and then think what to do.”
Reina: “Which do I open first, a mail from your office or a mail from your girlfriend?”
Takashi: “Of course, the mail from my girlfriend.”

Takashi answered questions one by one as if he was talking to someone while he was wondering who wrote the question. Takashi had enjoyed driving with Reina three times so far. Takashi first knew about Reina from Instagram (registered trademark) of one famous actor. One photograph posted by the actor showed a cup crossing an intersection. On the photograph, two people were highlighted by the lights of cars in the oncoming lane waiting for the two people to finish crossing the intersection. It was a nice photograph.

In a comments section of the photograph, “nice,” and # Akasaka # Couple # kinyoubi # ReinaDrive were posted. “ReinaDrive?” Takashi searched for “ReinaDrive”, and immediately found one driver. Takashi explored Reina, and found from blogs, SNS, Instagram (registered trademark), and Twitter (registered trademark) that many people enjoyed Reina's driving after their work. Every photograph and every video looked nice and made Takashi want to go for driving.

When Takashi finished answering all the questions, music started quietly from his smartphone. “It's about time?” Takashi threw the last dry-cured ham into his mouth and finished off his wine, and then stood up and left the bar. Takashi's car was just about to pull up alongside front of Takashi. The passenger's door of his car opened, and Takashi got into his car slowly. Music from his smartphone was playing in his car completely synchronously.

“It's on time. Let's go,” said Takashi while fastening his seatbelt. No one was sitting in the driver's seat, but he was able to feel Reina for some reason. For a moment, Takashi smelled Reina's fragrance, which was penetratingly strong and energetic. Reina stepped on the accelerator and started to speak at the same time.

Reina: “Where would you like to go?”

### Takashi: “ . . . ”

Reina: “Huh? Haven't you decided yet?”
Reina: “My choice again today?”
Takashi: “Yes, please.”
Reina: “Are you sure?”

Takashi said “yes”, and simultaneously the Reina's car running on Uchibori-dori Avenue suddenly made a U-turn at the end of a median strip, and Reina stepped on the accelerator. Takashi's body was shaken, and unexpected and shocking driving started, which made Takashi feel as if he was taken to a direction just opposite to a direction where he wanted to go. From the first, all destination request boxes were left blank today, and “two-hour driving” was only a condition given to the navigation system. Takashi was busy with his work, and wanted to forget everything. That was the beginning of this night.

Had Reina read what Takashi thought by these questions? She hadn't and was not able to do it. It seemed to Takashi that Reina grasped his schedule of the entire week, perhaps because of linked outlook information. Takashi remembered his yesterday's post of Twitter (registered trademark). Takashi tweeted “I want to be swayed by someone else once in a while,” because he felt anxious if he did not have confidence in his own decision-making all the time. The post had three favorites and two retweets by his followers, which eased Takashi's mind.

Takashi: “Reina, Reina, where are you going?”

### Reina: “Secret.”

### Takashi: “What?”

Reina's car entered the Shuto Expressway from the Hitotsubashi Junction, and started to run east. If the car went this way, Takashi would see his office. Takashi started to look for his office. Lights of his office were still on. Takashi felt a little guilty, because his junior colleague he left was working hard. Takashi saw the figure of a man through a window, and saw the man with magnification. The man was Takashi himself who was busy with work and tired. Takashi was startled, and remembered that he had been busy all week with work.

Music slowly and gently changed. The car slowly went around a curve of the Shuto Expressway, and Takashi was looking at his office vanishing. Suddenly, the big Tokyo Tower appeared from behind buildings. Takashi was overwhelmed by such a scene, and muttered, “Wow.” Reina smiled and said “I got you” in the car, and posted a photograph of the Tokyo Tower that he saw to Twitter (registered trademark). Reina added a comment, “Wow” muttered by Takashi to the post. The scene was the same as the photograph of the Tokyo Tower in the advertisement that Takashi saw in the train.

The next morning Takashi checked his Instagram (registered trademark), and he got a “Like” from that actor, and returned a comment.

In this example, Reina who was an artificial intelligence (AI) driver (drive editor) edited a driving route from a psychological situation of Takashi who was a user, what the user was seeing for a certain period of time (the Tokyo Tower in the advertisement), how the user spent a certain period of time in the past (outlook, physical data, motion data, utterance history, etc.), the degree of stress, desire (past muttering), a basic taste, preferences, past SNS posts, Facebook (registered trademark) posts, information from Twitter (registered trademark), etc. Reina selected a basic route within a limited period of time (two hours) for Takashi while grasping traffic conditions, etc. Reina addressed a conversational questionnaire to Takashi, and simultaneously a route suitable for Takashi's preferences was set from the database of Reina who was an artificial intelligence AI driver. In the two-hour conversation, Reina read conversation with Takashi and a slight change in his mood, and re-edited the driving route as necessary.

Driving is basically edited to fill up four contents of “introduction”, “development”, “twist”, and “conclusion”.

Introduction: Picking up from inspiration. A drama starts with surprise.
Development: A user is taken to another world with amazement, surprise, unexpected movement, and unexpected behavior.
Twist: The user experiences uncontrolled stimulation that goes on and freshness that is different from a user's will.
Conclusion: The user is caused to remember user's normal activities and check the user's hidden desire against the user's normal activities, thereby causing the user to “notice” a gap between them. The driving is finished in a sense of security at the end. The four contents of “introduction”, “development”, “twist”, and “conclusion” has two courses, that is, a user's choice course determined by the user and a recommended course determined by a service (AI) side.

### Example 2

The experience described in the example 1 was executed by autonomous driving by the artificial intelligence (AI) driver (the drive editor), but may also be executed by manned driving with a real driver.

### Example 3

In the example 1, the navigation system 1 may cause an electronic bulletin board along a driving route to display an advertisement of an advertiser only for a predetermined period of time in which the user of the navigation system 1 is able to visually recognize the electronic bulletin board during the driving.

Although the present technology has been described with reference to the embodiment and the modification examples thereof, the present technology is not limited to the foregoing embodiment, etc., and may be modified in a variety of ways. It is to be noted that effects described in this specification are merely illustrative. Effects of the present technology are not limited to the effects described in this specification. The present technology may have effects other than the effects described in this specification.

In addition, for example, the present disclosure may have the following configurations.

(1)

A navigation device including:

an acceptance unit that accepts a request;

a determination unit that determines a representation allowing a user to have fun while traveling on the basis of the request accepted by the acceptance unit; and

an output unit that generates a control signal causing a representation device to perform the representation determined by the determination unit, and outputs the control signal to the representation device.

(2)

The navigation device according to (1), in which the request includes information about a situation, a mood or a preference of the user.

(3)

The navigation device according to (2), in which the situation of the user includes information about a schedule or spare time of the user.

(4)

The navigation device according to (1), in which the request includes information about a drive editor designated by the user, and the representation includes a representation by the drive editor designated in the request.

(5)

The navigation device according to (4), in which

the request includes information about interaction that the user has performed with the drive editor, and

the determination unit determines the representation on the basis of the interaction included in the request.

(6)

The navigation device according to (1), in which

the request includes information about an advertisement selected by the user, and

the representation includes a representation set for the advertisement selected in the request.

(7)

The navigation device according to (1), in which

the request includes setting information that is necessary for setting a driving route and is inputted by the user, and

the determination unit determines the driving route and the representation on the basis of the setting information included in the request.

(8)

The navigation device according to (7), in which the setting information includes information about a departure point, an arrival point, or a via point.

(9)

The navigation device according to (8), in which the setting information includes information obtained by driving by a person other than the user.

(10)

The navigation device according to (1), in which, in a case where information about an arrival point, a via point, or a via route is not included in the request, the determination unit conceals the arrival point, the via point, or the via route that is determined on the basis of the request for a predetermined period of time without unconditionally notifying the user of the arrival point, the via point, or the via route.

(11)

The navigation device according to any one of (1) to (10), in which

the navigation device further includes the representation device, and

the representation device includes VR (virtual reality) spectacles.

(12)

A navigation information processing device including:

a storage unit that stores a plurality of pieces of navigation information including route information and information about a situation, a mood, or a preference of a user, the route information including a departure point, an arrival point, and a via point, the information being associated with the route information; and

a transmitter that reads the navigation information corresponding to a request from an external device from among the plurality of pieces of navigation information stored in the storage unit, and transmits the navigation information to the external device.

(13)

A navigation information acceptance device including:

an acceptance unit that accepts information about a situation, a mood, or a preference of a user as a request during driving; and

a transmitter that transmits the request accepted by the acceptance unit together with route information including a departure point, an arrival point, and a via point to a server device.

(14)

The navigation information acceptance device according to (13), further including:

a display unit;
a speaker unit;
a receiver in which the transmitter receives a first control signal from the server device, the first control signal causing a representation corresponding to the request to be performed; and

an output unit that outputs the first control signal received by the receiver or a second control signal obtained by performing predetermined processing on the first control signal to the display unit and the speaker unit and also to an in-vehicle device of a moving body simultaneously.

(15)

The navigation information acceptance device according to (13) or (14), further including:

a VR (Virtual Reality) spectacles:

a receiver that receives a first control signal from the server device, the first control signal causing a representation corresponding to the request to be performed; and

an output unit that outputs, to the VR spectacles, the first control signal received by the receiver or a second control signal obtained by performing predetermined processing on the first control signal.

This application claims the benefit of Japanese Priority Patent Application JP2017-127694 filed with the Japan Patent Office on Jun. 29, 2017, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A navigation device comprising:
an acceptance unit that accepts a request;
a determination unit that determines a representation allowing a user to have fun while traveling on a basis of the request accepted by the acceptance unit; and
an output unit that generates a control signal causing a representation device to perform the representation determined by the determination unit, and outputs the control signal to the representation device.

2. The navigation device according to claim 1, wherein the request includes information about a situation, a mood or a preference of the user.

3. The navigation device according to claim 2, wherein the situation of the user includes information about a schedule or spare time of the user.

4. The navigation device according to claim 1, wherein
the request includes information about a drive editor designated by the user, and
the representation includes a representation by the drive editor designated in the request.

5. The navigation device according to claim 4, wherein
the request includes information about interaction that the user has performed with the drive editor, and
the determination unit determines the representation on a basis of the interaction included in the request.

6. The navigation device according to claim 1, wherein
the request includes information about an advertisement selected by the user, and
the representation includes a representation set for the advertisement selected in the request.

7. The navigation device according to claim 1, wherein
the request includes setting information that is necessary for setting a driving route and is inputted by the user, and
the determination unit determines the driving route and the representation on a basis of the setting information included in the request.

8. The navigation device according to claim 7, wherein the setting information includes information about a departure point, an arrival point, or a via point.

9. The navigation device according to claim 8, wherein the setting information comprises information obtained by driving by a person other than the user.

10. The navigation device according to claim 1, wherein, in a case where information about an arrival point, a via point, or a via route is not included in the request, the determination unit conceals the arrival point, the via point, or the via route that is determined on a basis of the request for a predetermined period of time without unconditionally notifying the user of the arrival point, the via point, or the via route.

11. The navigation device according to claim 1, wherein
the navigation device further includes the representation device, and
the representation device includes VR (virtual reality) spectacles.

12. A navigation information processing device comprising:
a storage unit that stores a plurality of pieces of navigation information including route information and information about a situation, a mood, or a preference of a user, the route information including a departure point, an arrival point, and a via point, the information being associated with the route information; and
a transmitter that reads the navigation information corresponding to a request from an external device from among the plurality of pieces of navigation information stored in the storage unit, and transmits the navigation information to the external device.

13. A navigation information acceptance device comprising:
an acceptance unit that accepts information about a situation, a mood, or a preference of a user as a request during driving; and
a transmitter that transmits the request accepted by the acceptance unit together with route information including a departure point, an arrival point, and a via point to a server device.

14. The navigation information acceptance device according to claim 13, further comprising:
a display unit;
a speaker unit;
a receiver that receives a first control signal from the server device, the first control signal causing a representation corresponding to the request to be performed; and
an output unit that outputs the first control signal received by the receiver or a second control signal obtained by performing predetermined processing on the first control signal to the display unit and the speaker unit and also to an in-vehicle device of a moving body simultaneously.

15. The navigation information acceptance device according to claim 13, further comprising:
a VR (Virtual Reality) spectacles:
a receiver that receives a first control signal from the server device, the first control signal causing a representation corresponding to the request to be performed; and
an output unit that outputs, to the VR spectacles, the first control signal received by the receiver or a second control signal obtained by performing predetermined processing on the first control signal.
